(19) United States
(12) Patent Application Publication
(10) Pub. No.: US 2012/0134148 A1
(43) Pub. Date: May 31, 2012

(54) LED LIGHTING WITH INCANDESCENT LAMP COLOR TEMPERATURE BEHAVIOR

(75) Inventors: Berend Jan Willem Ter Weeme, Eindhoven (NL); William Peter Mechtildis Marie Jans, Eindhoven (NL); Theo Gerrit Zijlman, Eindhoven (NL); Gazi Akdag, Eindhoven (NL); Erik Martinus Hubertus Petrus Van Dijk, Eindhoven (NL); Paul Johannes Marie Julicher, Eindhoven (NL); Bertrand Johan Edward Hontele, Eindhoven (NL)

(73) Assignee: KONINKLIJKE PHILIPS ELECTRONICS N.V., EINDHOVEN (NL)

(21) Appl. No.: 13/255,956

(22) PCT Filed: Mar. 11, 2010
(86) PCT No.: PCT/IB10/51053

§ 371 Date: Dec. 22, 2011

(30) Foreign Application Priority Data
Mar. 12, 2009 (EP) 09154950.1

(51) Int. Cl. F21V 9/00

(52) U.S. Cl. 362/231

(57) ABSTRACT

In a lighting device, sets of LEDs are employed using the natural characteristics of the LEDs to resemble incandescent lamp behavior when dimmed, thereby obviating the need for sophisticated controls. A first set of at least one LED produces light with a first color temperature, and a second set of at least one LED produces light with a second color temperature. The first set and the second set are connected in series, or the first set and the second set are connected in parallel, possibly with a resistive element in series with the first or the second set. The first set and the second set differ in temperature behavior, or have different dynamic electrical resistance. The light device produces light with a color point parallel and close to a blackbody curve.

### FIELD OF THE INVENTION

The invention relates to the field of LED lighting devices, and more specifically to a LED lighting device having an incandescent lamp color temperature behavior when dimmed. The invention further relates to a kit of parts comprising a LED lighting device and a dimming device.

### BACKGROUND OF THE INVENTION

Since many decades, people have been used to the light of incandescent lamps of different powers. The light of an incandescent lamp provides a general feeling of well-being. Generally, the lower the power of the incandescent lamp is, the lower the color temperature of the light emitted by the lamp is. As a characterization, the human perception of the light is “warmer” when the color temperature is lower. With one and the same incandescent lamp, the lower the power supplied to the lamp is, which occurs when the lamp is dimmed, the lower the color temperature of the emitted light is.

In LED lighting devices, a behavior of the color temperature of the LED light can be obtained which, in dimming conditions, is similar to that of an incandescent lamp, but until now only at the expense of extensive current control, such as e.g. known from DE10230105. The necessity of adding controls to the LED lighting device for the desired color temperature behavior increases the number of components, increases the complexity of the lighting device, and increases costs. These effects are undesirable.

### SUMMARY OF THE INVENTION

It would be desirable to provide an LED lighting device having a color temperature behavior, when dimmed, resembling or approaching the color temperature behavior of an incandescent lamp, when dimmed. It would also be desirable to provide an LED lighting device having an incandescent lamp color temperature behavior, when dimmed, without the need of extensive controls.

To better address one or more of these concerns, in a first aspect of the invention a LED lighting device is provided, comprising a plurality of LEDs, and two terminals for supplying current to the lighting device. The lighting device comprises a first set of at least one LED of a first type producing light having a first color temperature, and a second set of at least one LED of a second type producing light having a second color temperature different from the first color temperature. The first set and the second set are connected in series or in parallel between the terminals. The lighting device is configured to produce light with a color point varying in accordance with a blackbody curve at a variation of an average current supplied to the terminals.

A color temperature behavior of an incandescent lamp may be described by the following relationship:

CT(x%)=CT(100%)*(x/100) 1/9.5

where CT(100%) is the color temperature of the light at full power (100% current) of the lamp, CT(x %) is the color temperature of the light at x % dimming (x % current, with 0≦x≦100) of the lamp.

In an embodiment, the first set has a varying first luminous flux output as a function of junction temperature of the LED of the first type, and the second set has a varying second luminous flux output as a function of junction temperature of the LED of the second type, and wherein, at varying junction temperatures, the ratio of the first luminous flux output to the second luminous flux output varies. In particular, when the first color temperature is lower than the second color temperature, the lighting device is configured such that, at decreasing junction temperatures, the ratio of the first luminous flux output to the second luminous flux output increases, and vice versa. In such a configuration, e.g. having the first set connected in series with the second set, the first luminous flux output increases relative to the second flux output when the lighting device is dimmed, thereby producing light having a lower color temperature.

In an embodiment, the first set has a first dynamic electrical resistance, and the second set has a second dynamic electrical resistance. When e.g. the first set is connected in parallel with the second set, different luminous flux outputs of the first set and the second set result, which can be designed to produce light having a lower color temperature when dimmed.

In a second aspect of the present invention, a lighting kit of parts is provided, comprising a dimmer having input terminals adapted to be connected to an electrical power supply, and having output terminals adapted to provide a variable electrical power. An embodiment of the lighting device according to the present invention has terminals configured to be connected to the output terminals of the dimmer.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts an LED lighting device in a first embodiment of the present invention, powered by a current source.

FIG. 2 illustrates relationships between luminous flux and temperature for different types of LEDs.

FIG. 3 illustrates further relationships between luminous flux and temperature for different types of LEDs.

FIG. 4 illustrates a relationship between a luminous flux ratio and a dimming ratio for different types of LEDs.

FIG. 5 depicts a LED lighting device in a second embodiment of the present invention, powered by a current source.

FIG. 6 illustrates relationships between LED current and forward voltage for different types of LEDs, as well as a ratio of current through the first and second sets of LEDs of FIG. 5.

### DETAILED DESCRIPTION OF EMBODIMENTS

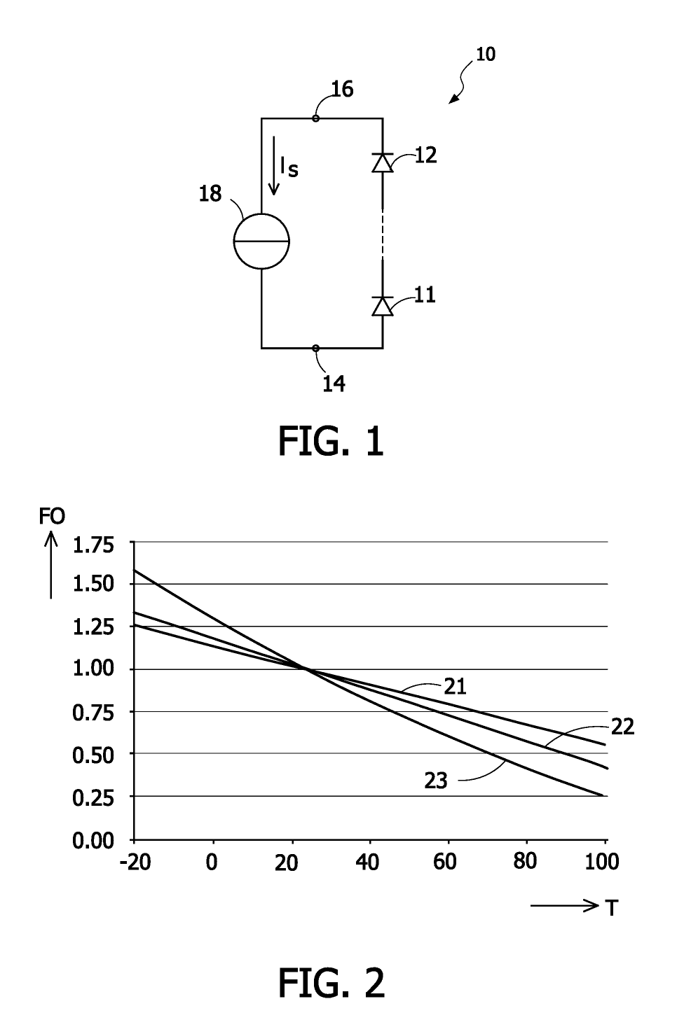

FIG. 1 depicts a lighting device 10 comprising at least one LED 11 of a first type, such as an AlInGaP type LED, and producing light having a first color temperature. The at least one LED 11 is connected in series with at least one LED 12 of a second type different from the first type, such as an InGaN type LED, and producing light having a second color temperature which is higher than the color temperature of an AlInGaP type LED. The lighting device 10 has two terminals 14, 16 for supplying a current I_{S} from a current source 18 to the series connection of LEDs 11, 12. The lighting device 10 has no active components. As indicated by a dashed line, the series connection LEDs of the lighting device 10 may comprise further LEDs 11 of the first type and/or LEDs 12 of the second type, such that the lighting device 10 comprises a plurality of LEDs 11 of the first type and/or a plurality of LEDs 12 of the second type. The lighting device 10 may further comprise one or more of any other type of LEDs of a third type different from the first type and the second type.

The one or more LEDs 11 of the first type are selected to have a first luminous flux output as a function of temperature having a gradient which is different from the gradient of a second luminous flux output as a function of temperature of the one or more LEDs 12 of the second type. In practice, the luminous flux output FO variation may be characterized by a so-called hot-coldfactor, indicating a percentage of luminous flux loss from 25° C. to 100° C. junction temperature of the LED. This is illustrated by reference to FIGS. 2, 3 and 4.

FIG. 2 illustrates graphs of a luminous flux output FO (vertical axis, lumen/mW) as a function of temperature T (horizontal axis, ° C.) of different LEDs 11 of a first type. A first graph 21 illustrates a luminous flux output FO decrease at a temperature increase for a red photometric LED. A second graph 22 illustrates a steeper luminous flux output FO decrease than the graph 21 at a temperature increase for a red-orange photometric LED. A third graph 23 illustrates a still steeper luminous flux output FO decrease than the graphs 21 and 22 at a temperature increase for an amber photometric LED.

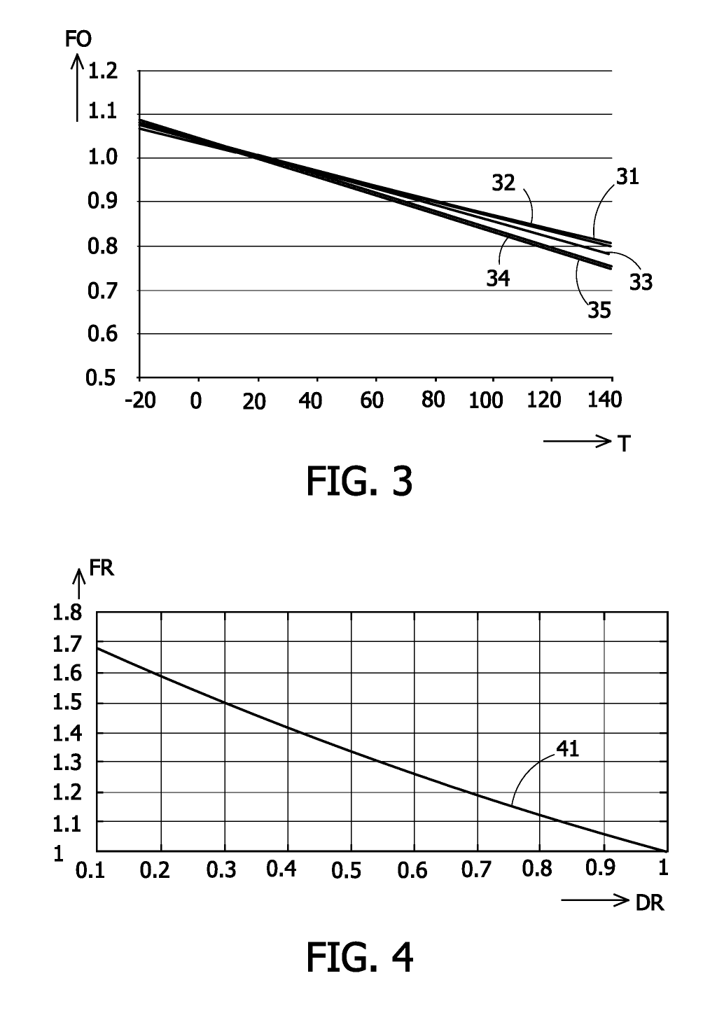

FIG. 3 illustrates graphs of a luminous flux output FO (vertical axis, lumen/mW) as a function of temperature T (horizontal axis, ° C.) of different LEDs 12 of a second type. A first graph 31 illustrates a luminous flux output FO decrease at a temperature increase for a cyan photometric LED. A second graph 32 illustrates a slightly steeper luminous flux output FO decrease than the graph 31 at a temperature increase for a green photometric LED. A third graph 33 illustrates a still steeper luminous flux output FO decrease than the graphs 31 and 32 at a temperature increase for a royal-blue radiometric LED. A fourth graph 34 illustrates a yet steeper luminous flux output FO decrease than the graphs 31, 32 or 33 at a temperature increase for a white photometric LED. A fifth graph 35 illustrates a still slightly steeper luminous flux output FO decrease than the graphs 31, 32, 33 or 34 at a temperature increase for a blue photometric LED.

FIGS. 2 and 3 show that an LED 11 of a first type has a higher hot-coldfactor than an LED 12 of a second type, indicating that the gradient of the luminous flux output as a function of temperature of the LED 11 is higher than the gradient of the luminous flux output as a function of temperature of the LED 12.

FIG. 4 illustrates a graph 41 of a luminous flux output ratio FR (vertical axis, dimensionless) of a string of LEDs 11 of the first type (red, orange, amber) having a relatively low color temperature, and a string of LEDs 12 of the second type (cyan, blue, white) having a relatively high color temperature, as a function of a dimming ratio DR (horizontal axis, dimensionless), where the temperature of all LED dies is 100° C. at 100% power (no dimming, i.e. dimming ratio=1), and ambient temperature is 25° C. The graph 41 illustrates a luminous flux output ratio FR decrease at a dimming ratio increase. Thus, according to FIG. 4, a lighting device 10 having the luminous flux ratio of the first and second sets of LEDs as shown will show a color temperature decrease when the lighting device 10 is dimmed. A particular luminous flux output ratio at a particular dimming ratio may be designed without undue experimentation by selecting appropriate types of LEDs in appropriate amounts, and selecting an appropriate thermal resistance to ambient of each LED of set of LEDs to obtain desired temperatures for the LED at particular dimming ratios. For example, the one or more LEDs of the first type, such as AlInGaP LEDs, may be mounted with a higher thermal resistance to ambient than the one or more LEDs of the second type, such as InGaN LEDs. In an appropriate design, the LED lighting device 10 will show a color temperature behavior like a color temperature behavior of an incandescent lamp, without additional controls.

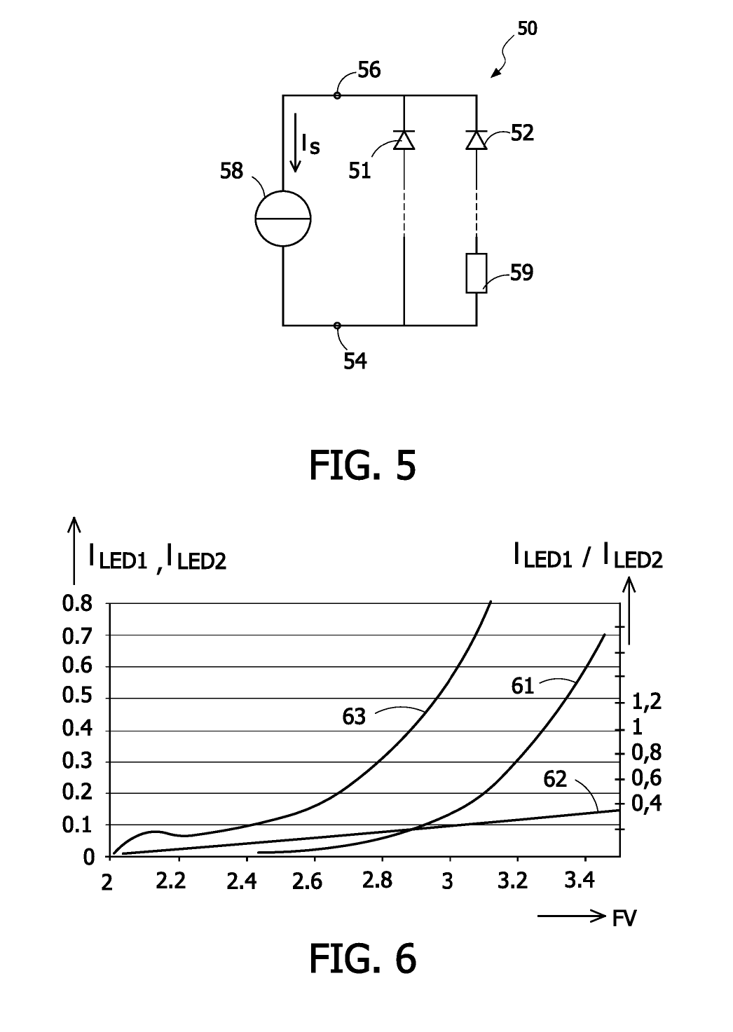

FIG. 5 depicts a lighting device 50 comprising at least one LED 51 of a first type, such as an AlInGaP type LED, connected in parallel with at least one LED 52 of a second type different from the first type, such as an InGaN type LED. The lighting device 50 has two terminals 54, 56 for supplying a current I_{S} from a current source 58 to the parallel connection of LEDs 51, 52. In series with the at least one LED 52, a resistor 59 is provided. The resistor 59 may also be connected in series with the at least one LED 51 instead of in series with the at least one LED 52. Alternatively, a resistor may be connected in series with the at least one LED 51 and another resistor may be connected in series with the at least one LED 52. The lighting device 50 has no active components. As indicated by dashed lines, the at least one LED 51 and the at least one LED 52 of the lighting device 50 may comprise further LEDs 51 and/or 52 such that the lighting device 50 comprises a plurality of LEDs 51 of the first type and/or a plurality of LEDs 52 of the second type. The lighting device 50 may further comprise one or more of any other type of LEDs of a third type different from the first type and the second type.

The resistor 59 is a negative temperature coefficient, NTC, type resistor, which will compensate relatively slow temperature variations by the variation of its resistance value.

The one or more LEDs 51 of the first type are selected to have a first dynamic resistance (measured as a ratio of a forward voltage across the LED(s) and a current through the LED(s)) which is different from a second dynamic resistance of the one or more LEDs 52 of the second type connected in series with the resistor 59. As a result, a ratio of the current through the one or more LEDs 51 of the first type and the current through the one or more LEDs 52 will be variable. This is illustrated by reference to FIG. 6.

FIG. 6 illustrates graphs of currents I_{LED1}, I_{LED2} (left vertical axis, A) as a function of forward voltage FV (horizontal axis, V) for LED(s) of a first and second type. Referring also to FIG. 5, a first graph 61 illustrates a current I_{LED1} in InGaN LED(s) 51 as a function of forward voltage across the LED(s) 51. A second graph 62 illustrates a current I_{LED2} in AlInGaP LED(s) 52 and resistor 59 as a function of forward voltage across the LED(s) 52 and resistor 59. In the illustrated example, the resistor 59 has a value of 8 ohm.

FIG. 6 further shows a graph 63 of the current ratio I_{LED1}/I_{LED2} (right vertical axis, dimensionless) as a function of forward voltage FV. As can be seen in graph 63, for forward voltages FV higher than ca. 2.9 V, a higher current I_{LED1} flows through the LED(s) 51 than the current I_{LED2} through the LED(s) 52 and resistor 59, whereas below a forward voltage FV of about 2.9 V, the current I_{LED1} is lower than I_{LED2}. Accordingly, when the current provided by the current source 58 is lowered in a dimming operation, the luminous flux output from the LED(s) 51, will decrease at a higher rate than the decrease of the luminous flux output from the LED(s) 52, such that the color temperature of the lighting device 50 will tend more towards the color temperature of the LED(s) 52 than at a higher current provided by the current source 58, where the color temperature of the lighting device 50 will tend towards the color temperature of the LED(s) 51. In an appropriate design, the LED lighting device 50 will thus show a color temperature behavior like a color temperature behavior of an incandescent lamp, without additional controls.

The current sources 18, 58 are configured to provide a DC current which may have a low current ripple. For dimming purposes, the current sources 18, 58 may be pulse width modulated. In case of the current source 18 feeding the lighting device 10, the junction temperatures of the LEDs will decrease when dimming. In case of current source 58, the average current during the time that a current flows in the lighting device 50, should be decreased during dimming. Thus, each current source 18, 58 is to be considered as a dimmer having output terminals which are adapted to provide a variable electrical power, in particular a variable current, and the terminals 14, 16 and 54, 56, respectively, are configured to be connected to the output terminals of the dimmer.

In the above it has been explained that in a lighting device sets of LEDs are employed using the natural characteristics of the LEDs to resemble incandescent lamp behavior when dimmed, thereby obviating the need for sophisticated controls. A first set of at least one LED produces light with a first color temperature, and a second set of at least one LED produces light with a second color temperature. The first set and the second set are connected in series, or the first set and the second set are connected in parallel, possibly with a resistive element in series with the first or the second set. The first set and the second set differ in temperature behavior, or have different dynamic electrical resistance. The light device produces light with a color point parallel and close to a blackbody curve.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly, and not necessarily mechanically.

1. Lighting device (100), comprising:
an LED driver (101) capable of generating dimmed LED current;
a two-terminal LED module (110; 300; 400; 500; 600), having two input terminals (111, 112) for receiving an input current (Iin) from the LED driver (101) and comprising:
a first LED group (113) comprising at least one first type LED for producing light having a first color temperature;
a second LED group (114) comprising at least one second type LED for producing light having a second color temperature different from the first color temperature;
wherein the module is capable of supplying LED currents to the LED groups, these LED currents being derived from the input current (Iin);
wherein the LED module produces a light output having at least a light output contributions from the first LED group (113) and from the second LED group (114);
and wherein the module is designed to vary the individual LED currents in the individual LED groups in dependency of the average magnitude of the received input current (Iin), such that the color point of the light output of the module varies as a function of the input current magnitude.

2. Lighting device according to claim 1, wherein the LED module is designed to vary the individual LED currents in the individual LED groups such that the color point of the light output of the module on dimming follows a black body curve.

3. Lighting device according to claim 1, wherein the LED module is designed to vary the individual LED currents in the individual LED groups such that the color behavior of the light output of the module on dimming resembles the color behavior of an incandescent lamp.

4. Lighting device according to claim 1, wherein the lighting device is configured to produce light with a color temperature CT at an average current of x %, CT(x %), supplied to the terminals following the relationship:
CT(x%)=CT(100%)*(x/100) 1/9.5

5. Lighting device according to claim 1, wherein the first group of LEDs has a varying first luminous flux output as a function of junction temperature of the first type LED, and the second group of LEDs has a varying second luminous flux output as a function of junction temperature of the second type LED, and wherein, at varying junction temperatures, the ratio of the first luminous flux output to the second luminous flux output varies;
and wherein preferably the first color temperature is lower than the second color temperature, while, at decreasing junction temperatures, the ratio of the first luminous flux output to the second luminous flux output increases, and vice versa.

6. Lighting device according to claim 1, wherein a gradient of the first luminous flux output as a function of junction temperature of the first type LED differs from a gradient of the second luminous flux output as a function of junction temperature of the second type LED;
and wherein preferably the first color temperature is lower than the second color temperature, while the absolute value of the gradient of the first luminous flux output as a function of temperature of the first type LED is higher than the gradient of the second luminous flux output as a function of temperature of the second type LED.

7. Lighting device according to claim 1, wherein a thermal resistance to ambient of the first group of LEDs differs from the thermal resistance to ambient of the second group of LEDs;
and wherein preferably the first color temperature is lower than the second color temperature, while the thermal resistance to ambient of the first group of LEDs is higher than the thermal resistance to ambient of the second group of LEDs.

8. Lighting device according to claim 1, wherein the first group of LEDs has a first dynamic electrical resistance, and the second group of LEDs has a second dynamic electrical resistance.

9. Lighting device according to claim 1, wherein one of the first group of LEDs and the second group of LEDs is connected in series with a resistor, and wherein this series arrangement is connected in parallel to the other one of the first group of LEDs and the second group of LEDs, and wherein this parallel arrangement is connected between the two input terminals (111, 112) of the LED module;
and wherein preferably the resistor is a negative temperature coefficient, NTC, type resistor.

10. Lighting device according to any of the preceding claims, wherein the first type LED is an AlInGaP type LED, and/or wherein the second type LED is an InGaN type LED.

11. Lighting device according to claim 1, wherein the LED module comprises an electronic division circuit (115) capable of controlling the LED currents (I1, I2) in said two groups (113, 114) of LEDs as a function of the input current level received at the input of the LED module.

12. Lighting device according to claim 11, wherein the electronic division circuit is capable of supplying the two groups of LEDs with constant current and of controlling the LED currents (I1, I2) such that the following formulas apply:
I1=p·Iin and I2=q·Iin, and p+q=1
with Iin denoting the input current magnitude,
I1 denoting the current magnitude in the first group of LEDs,
I2 denoting the current magnitude in the second group of LEDs;
wherein there is at least a range of input current magnitudes where dp/d(Iin) is always positive and dq/d(Iin) is always negative.

13. Lighting device according to claim 12, wherein the LED module comprises:
a current regulating element (320) arranged in series with one of said groups of LEDs, this series arrangement being coupled in parallel to another of said groups of LEDs;
a current sensing element (350) arranged for sensing the input current received at the input terminals of the LED module;
and a regulator driver (310) receiving a sense output signal from the sensing element and driving the current regulating element on the basis of this sense output signal.

14. Lighting device according to claim 11, wherein the electronic division circuit (515) comprises a controllable switch (501) for temporally dividing de received input current (Iin) between the two groups of LEDs;
a control device (520) for controlling the switch (501) at a switching period T such that the input current is passed on to the first group of LEDs for a first time duration t1 and the input current is passed on to the second group of LEDs for a second time duration t2, with t1+t2=T;
a current sensing element (116) arranged for sensing the input current received at the input terminals of the LED module;
the control device being coupled to receive a sense output signal from the sensing element and being designed to vary the ratio t1/t2 of the switching of the switch on the basis of said sense output signal, such that there is at least a range of input current magnitudes where dt1(Iin) is always positive and dt2(Iin) is always negative.

15. Lighting device according to claim 11, wherein the second group of LEDs (114) is supplied by a current converter (601) having its input terminals connected in parallel to the first group of LEDs (113);
wherein the current converter comprises a control circuit (620) receiving a sense output signal from a current sensing element (116) sensing the input current of the LED module;
and wherein this control circuit (620) is designed to control the current converter (601) on the basis of the sense output signal received from the current sensing element (116).

16. Lighting device according to claim 11, wherein the first group of LEDs (113) is supplied by a first current converter (730) and the second group of LEDs (114) is supplied by a second current converter (740), and wherein these two current converter have their input terminals connected in series;
wherein the LED module comprises a control circuit (720) receiving a sense output signal from a current sensing element (116) sensing the input current of the LED module;
and wherein this control circuit (720) is designed to control the current converters (730, 740) on the basis of the sense output signal received from the current sensing element (116).
